(19) United States
(12) Patent Application Publication
(10) Pub. No.: US 2022/0309920 A1
(43) Pub. Date: Sep. 29, 2022

(54) CONTROLLING VEHICLE-INFRASTRUCTURE COOPERATED AUTONOMOUS DRIVING

(71) Applicant: APOLLO INTELLIGENT CONNECTIVITY (BEIJING) TECHNOLOGY CO., LTD., BEIJING (CN)

(72) Inventors: Guoyi YANG, BEIJING (CN); Wen ZHANG, BEIJING (CN); Fan YANG, BEIJING (CN); Kun WANG, BEIJING (CN); Maoyang HU, BEIJING (CN)

(21) Appl. No.: 17/841,415

(22) Filed: Jun. 15, 2022

(30) Foreign Application Priority Data
Jun. 23, 2021 (CN) 202110700427.2
Sep. 30, 2021 (CN) 202111162252.0

(51) Int. Cl. G08G 1/0967; G08G 1/01

(52) U.S. Cl. CPC G08G 1/096725; G08G 1/096783; G08G 1/0116; G08G 1/0133; G08G 1/0141; G08G 1/0145

(57) ABSTRACT

A method and an apparatus for controlling vehicle-infrastructure cooperated autonomous driving, an electronic device, a medium, a vehicle, and a cooperative vehicle-infrastructure system are provided relating to the technical field of artificial intelligence and, in particular, to the technical field of autonomous driving and intelligent transportation. An implementation includes: obtaining first detection information in a detectable range of a first vehicle; determining, based on the first detection information, that the first vehicle is in a jammed state on a current traveling lane; in response to determining that the first vehicle is in the jammed state on the current traveling lane, obtaining second detection information by using an infrastructure system, where the second detection information includes information out of the detectable range of the first vehicle; and determining a control decision for the first vehicle based on the second detection information.

### CROSS REFERENCE TO RELATED APPLICATIONS

This application claims priority to Chinese Patent Application No. 202111162252.0, filed on Sep. 30, 2021, and Chinese Patent Application No. 202110700427.2, filed on Jun. 23, 2021, the contents of both of which are hereby incorporated by reference in their entireties for all purposes.

### TECHNICAL FIELD

The present disclosure relates to the technical field of artificial intelligence and, in particular, to the technical field of autonomous driving and intelligent transportation, and specifically to a method and an apparatus for controlling vehicle-infrastructure cooperated autonomous driving, an electronic device, a computer-readable storage medium, a computer program product, a vehicle, and a cooperative vehicle-infrastructure system.

### BACKGROUND

At present, autonomous driving mainly depends on vehicle autonomous driving (AD). During the vehicle AD, environment sensing, computation, and decision making, and control are performed mainly based on vision of a vehicle, sensors such as a millimeter-wave radar and a laser radar, a computing unit, and a drive-by-wire system.

The method described in this section is not necessarily a method that has been previously conceived or employed. It should not be assumed that any of the methods described in this section is considered to be the prior art just because they are included in this section, unless otherwise indicated expressly. Similarly, the problem mentioned in this section should not be considered to be universally recognized in any prior art, unless otherwise indicated expressly.

### SUMMARY

The present disclosure provides a method and an apparatus for controlling vehicle-infrastructure cooperated autonomous driving, an electronic device, a computer-readable storage medium, a computer program product, a vehicle, and a cooperative vehicle-infrastructure system.

According to an aspect of the present disclosure, there is provided a method for controlling vehicle-infrastructure cooperated autonomous driving, the method including: obtaining first detection information in a detectable range of a first vehicle; determining, based on the first detection information, that the first vehicle is in a jammed state on a current traveling lane; in response to determining that the first vehicle is in the jammed state on the current traveling lane, obtaining second detection information by using an infrastructure system, where the second detection information includes information out of the detectable range of the first vehicle; and determining a control decision for the first vehicle based on the second detection information.

According to an aspect of the present disclosure, there is provided an electronic device, including: a processor; and a memory communicatively connected to the processor, where the memory stores instructions executable by the processor, and when executed by the processor, the instructions cause the processor to perform acts including: obtaining first detection information in a detectable range of a first vehicle; determining, based on the first detection information, that the first vehicle is in a jammed state on a current traveling lane; in response to determining that the first vehicle is in the jammed state on the current traveling lane, obtaining second detection information by using an infrastructure system, where the second detection information comprises information out of the detectable range of the first vehicle; and determining a control decision for the first vehicle based on the second detection information.

According to an aspect of the present disclosure, there is provided a non-transient computer-readable storage medium storing computer instructions, where the computer instructions are used to cause a computer to perform the acts including: obtaining first detection information in a detectable range of a first vehicle; determining, based on the first detection information, that the first vehicle is in a jammed state on a current traveling lane; in response to determining that the first vehicle is in the jammed state on the current traveling lane, obtaining second detection information by using an infrastructure system, wherein the second detection information comprises information out of the detectable range of the first vehicle; and determining a control decision for the first vehicle based on the second detection information.

It should be understood that the content described in this section is not intended to identify critical or important features of the embodiments of the present disclosure, and is not used to limit the scope of the present disclosure. Other features of the present disclosure will be easily understood through the following description.

### BRIEF DESCRIPTION OF THE DRAWINGS

The drawings exemplarily show embodiments and form a part of the specification, and are used to explain example implementations of the embodiments together with a written description of the specification. The embodiments shown are merely for illustrative purposes and do not limit the scope of the claims. Throughout the drawings, identical reference signs denote similar but not necessarily identical elements.

FIG. 1 is a schematic diagram of an example system in which various methods described herein can be implemented according to an embodiment of the present disclosure;

FIG. 2 is a flowchart of a method for controlling vehicle-infrastructure cooperated autonomous driving according to an embodiment of the present disclosure;

FIG. 3A is a schematic diagram of a method for controlling vehicle-infrastructure cooperated autonomous driving according to an embodiment of the present disclosure;

FIG. 3B is a schematic diagram of another method for controlling vehicle-infrastructure cooperated autonomous driving according to an embodiment of the present disclosure;

FIG. 4 is a structural block diagram of an apparatus for controlling vehicle-infrastructure cooperated autonomous driving according to an embodiment of the present disclosure; and

FIG. 5 is a structural block diagram of an example electronic device that can be used to implement an embodiment of the present disclosure.

### DETAILED DESCRIPTION

Example embodiments of the present disclosure are described below in conjunction with the accompanying drawings, where various details of the embodiments of the present disclosure are included to facilitate understanding, and should only be considered as example. Therefore, those of ordinary skill in the art should be aware that various changes and modifications can be made to the embodiments described herein, without departing from the scope of the present disclosure. Likewise, for clarity and conciseness, description of well-known functions and structures are omitted in the following descriptions.

In the present disclosure, unless otherwise stated, the terms “first”, “second”, etc., used to describe various elements are not intended to limit the positional, temporal or importance relationship of these elements, but rather only to distinguish one component from another. In some examples, the first element and the second element may refer to the same instance of the element, and in some cases, based on contextual descriptions, the first element and the second element may also refer to different instances.

The terms used in the description of the various examples in the present disclosure are merely for the purpose of describing particular examples, and are not intended to be limiting. If the number of elements is not specifically defined, there may be one or more elements, unless otherwise expressly indicated in the context. Moreover, the term “and/or” used in the present disclosure encompasses any of and all possible combinations of listed items.

In a current autonomous driving field, a vehicle autonomous driving technology is commonly used. During vehicle autonomous driving, environment sensing means that sensors mounted on a vehicle complete a function of detecting and positioning a surrounding environment. Computation and decision making means that data of the sensors is analyzed to recognize a target, and also means that behavior prediction, global path planning, local path planning, and instant action planning are performed to determine a current and future movement trajectory of the vehicle. Control mainly includes vehicle movement control and human-computer interaction, which determines a control signal of an actuator such as a motor, an accelerator pedal, and a brake.

However, vehicle autonomous driving is limited by a mounting position, a detection distance, an angle of view, a data throughput, a computing capability, calibration precision, time synchronization, and the like of vehicle sensors. When the vehicle travels under environmental conditions such as a busy crossroads, a severe weather, recognition by a small object sensing and recognizing signal light, and backlighting, problems of accurate sensing and recognition and high-precision positioning can hardly be solved thoroughly, and application requirements of people on autonomous driving technologies at present cannot be met.

In view of this, the present disclosure provides a method that can perform automatic control on a vehicle by using an infrastructure system. The method includes: in response to determining that a first vehicle is in a jammed state on a current traveling lane, obtaining second detection information by using the infrastructure system, where the second detection information includes information out of a detectable range of the first vehicle; and determining a control decision for the first vehicle at least based on the second detection information. In this way, when the first vehicle is in the jammed state, the control decision for the first vehicle may be determined by using the detection information obtained by using the infrastructure system, thereby improving a sensing capability of the first vehicle and implementing a more accurate control decision.

Embodiments of the present disclosure will be described below in detail in conjunction with the drawings.

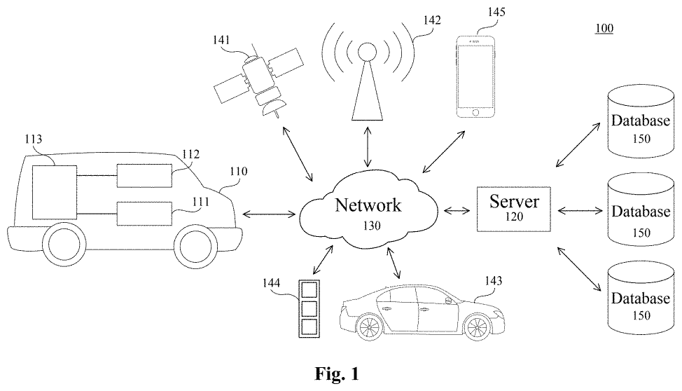

FIG. 1 is a schematic diagram of an example system 100 in which various methods and apparatuses described in the present disclosure can be implemented according to an embodiment of the present disclosure. Referring to FIG. 1, the system 100 includes a motor vehicle 110, a server 120, and one or more communications networks 130 that couple the motor vehicle 110 to the server 120.

In this embodiment of the present disclosure, the motor vehicle 110 may include a computing device according to embodiments of the present disclosure and/or may be configured to perform the method according to embodiments of the present disclosure.

The server 120 can run one or more services or software applications that enable an autonomous driving method to be implemented. In some embodiments, the server 120 may further provide other services or software applications that may include a non-virtual environment and a virtual environment. In the configuration shown in FIG. 1, the server 120 may include one or more components that implement functions performed by the server 120. These components may include software components, hardware components, or a combination thereof that can be executed by one or more processors. A user of the motor vehicle 110 may sequentially use one or more client application programs to interact with the server 120, thereby utilizing the services provided by these components. It should be understood that various system configurations are possible, which may be different from the system 100. Therefore, FIG. 1 is an example of the system for implementing various methods described in the present disclosure, and is not intended to be limiting.

The server 120 may include one or more general-purpose computers, a dedicated server computer (e.g., a personal computer (PC) server, a UNIX server, or a terminal server), a blade server, a mainframe computer, a server cluster, or any other suitable arrangement and/or combination. The server 120 may include one or more virtual machines running a virtual operating system, or other computing architectures relating to virtualization (e.g., one or more flexible pools of logical storage devices that can be virtualized to maintain virtual storage devices of a server). In various embodiments, the server 120 can run one or more services or software applications that provide functions described below.

A computing unit in the server 120 can run one or more operating systems including any of the above-mentioned operating systems and any commercially available server operating system. The server 120 can also run any one of various additional server application programs and/or middle-tier application programs, including an HTTP server, an FTP server, a CGI server, a JAVA server, a database server, etc.

In some implementations, the server 120 may include one or more application programs to analyze and merge data feeds and/or event updates received from the motor vehicle 110. The server 120 may further include one or more application programs to display the data feeds and/or real-time events via one or more display devices of the motor vehicle 110.

The network 130 may be any type of network well known to those skilled in the art, and it may use any one of a plurality of available protocols (including but not limited to TCP/IP, SNA, IPX, etc.) to support data communication. As a mere example, the one or more networks 130 may be a satellite communication network, a local area network (LAN), an Ethernet-based network, a token ring, a wide area network (WAN), the Internet, a virtual network, a virtual private network (VPN), an intranet, an extranet, a public switched telephone network (PSTN), an infrared network, a wireless network (such as Bluetooth or Wi-Fi), and/or any combination of these and other networks.

The system 100 may further include one or more databases 150. In some embodiments, these databases can be used to store data and other information. For example, one or more of the databases 150 can be used to store information such as an audio file and a video file. The database 150 may reside in various locations. For example, a database used by the server 120 may be locally in the server 120, or may be remote from the server 120 and may communicate with the server 120 via a network-based or dedicated connection. The database 150 may be of different types. In some embodiments, the database used by the server 120 may be a database, such as a relational database. One or more of these databases can store, update, and retrieve data from or to the database, in response to a command.

In some embodiments, one or more of the databases 150 may also be used by an application program to store application program data. The database used by the application program may be of different types, for example, may be a key-value repository, an object repository, or a regular repository backed by a file system.

The motor vehicle 110 may include a sensor 111 for sensing the surrounding environment. The sensor 111 may include one or more of the following sensors: a visual camera, an infrared camera, an ultrasonic sensor, a millimeter-wave radar, and a laser radar (LiDAR). Different sensors can provide different detection precision and ranges. Cameras can be mounted in the front of, at the back of, or at other locations of the vehicle. Visual cameras can capture the situation inside and outside the vehicle in real time and present it to the driver and/or passengers. In addition, by analyzing the image captured by the visual cameras, information such as indications of traffic lights, conditions of crossroads, and operating conditions of other vehicles can be obtained. Infrared cameras can capture objects in night vision. Ultrasonic sensors can be mounted around the vehicle to measure the distances of objects outside the vehicle from the vehicle using characteristics such as the strong ultrasonic directivity. Millimeter-wave radars can be mounted in the front of, at the back of, or at other locations of the vehicle to measure the distances of objects outside the vehicle from the vehicle using the characteristics of electromagnetic waves. Laser radars can be mounted in the front of, at the back of, or at other locations of the vehicle to detect edge and shape information of objects, so as to perform object recognition and tracking. Due to the Doppler effect, the radar apparatuses can also measure the velocity changes of vehicles and moving objects.

The motor vehicle 110 may further include a communication apparatus 112. The communication apparatus 112 may include a satellite positioning module that can receive satellite positioning signals (for example, BeiDou, GPS, GLONASS, and GALILEO) from a satellite 141 and generate coordinates based on the signals. The communication apparatus 112 may further include a module for communicating with a mobile communication base station 142. The mobile communication network can implement any suitable communication technology, such as GSM/GPRS, CDMA, LTE, and other current or developing wireless communication technologies (such as 5G technology). The communication apparatus 112 may further have an Internet of Vehicles or vehicle-to-everything (V2X) module, which is configured to implement communication between the vehicle and the outside world, for example, vehicle-to-vehicle (V2V) communication with other vehicles 143 and vehicle-to-infrastructure (V2I) communication with infrastructures 144. In addition, the communication apparatus 112 may further have a module configured to communicate with a user terminal 145 (including but not limited to a smartphone, a tablet computer, or a wearable apparatus such as a watch) by using a wireless local area network or Bluetooth of the IEEE 802.11 standards. With the communication apparatus 112, the motor vehicle 110 may further access the server 120 via the network 130.

The motor vehicle 110 may further include a control apparatus 113. The control apparatus 113 may include a processor that communicates with various types of computer-readable storage apparatuses or media, such as a central processing unit (CPU) or a graphics processing unit (GPU), or other dedicated processors. The control apparatus 113 may include an autonomous driving system for automatically controlling various actuators in the vehicle. The autonomous driving system is configured to control a powertrain, a steering system, a braking system, and the like (not shown) of the motor vehicle 110 via a plurality of actuators in response to inputs from a plurality of sensors 111 or other input devices to control acceleration, steering, and braking, respectively, with no human intervention or limited human intervention. Part of the processing functions of the control apparatus 113 can be implemented by cloud computing. For example, a vehicle-mounted processor can be used to perform some processing, while cloud computing resources can be used to perform other processing. The control apparatus 113 may be configured to perform the method according to the present disclosure. In addition, the control apparatus 113 may be implemented as an example of a computing device of the motor vehicle (client) according to the present disclosure.

It can be understood that the motor vehicle does not necessarily include the foregoing various vehicle sensing devices. According to some embodiments of the present disclosure, the motor vehicle can still implement safe and reliable autonomous driving under the condition that the vehicle sensing devices do not exist or are not started.

The infrastructures in the present disclosure may include road work and matched ancillary facilities, intelligent sensing facilities such as a camera, a millimeter-wave radar, and a laser radar, roadside communication facilities such as Wi-Fi Direct communication facilities and cellular mobile communication facilities, computing control facilities such as edge computing nodes, MEC, or all levels of cloud platforms, high-precision maps, and auxiliary positioning facilities, matched ancillary devices such as power functions, and the like.

The system 100 of FIG. 1 may be configured and operated in various manners, such that the various methods and apparatuses described according to the present disclosure can be applied.

In the technical solutions of the present disclosure, collecting, storage, use, processing, transmitting, providing, disclosing, etc. of personal information of a user involved all comply with related laws and regulations and are not against the public order and good morals.

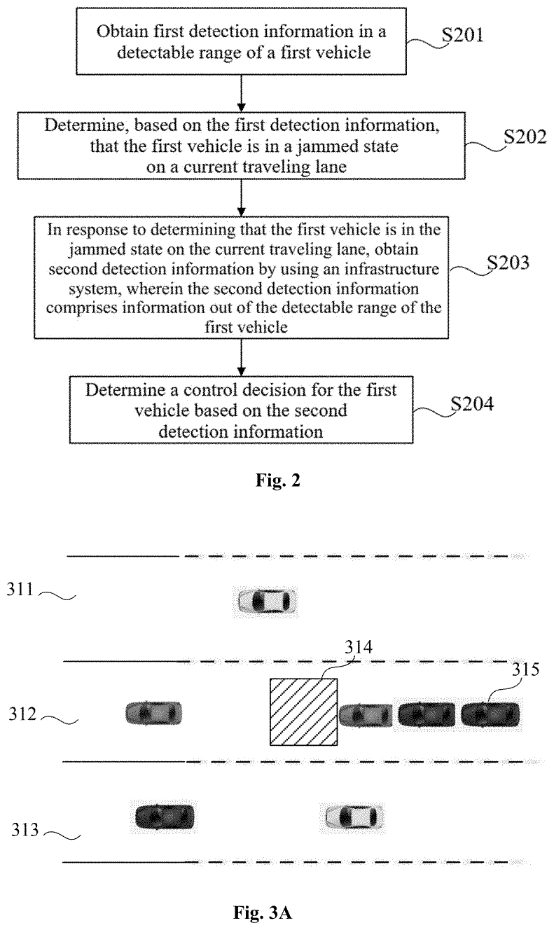

FIG. 2 illustrates a method for controlling vehicle-infrastructure cooperated autonomous driving according to an example embodiment of the present disclosure. The method includes: step S201: obtaining first detection information in a detectable range of a first vehicle; step S202: determining, based on the first detection information, that the first vehicle is in a jammed state on a current traveling lane; step S203: in response to determining that the first vehicle is in the jammed state on the current traveling lane, obtaining second detection information by using an infrastructure system, where the second detection information includes information out of the detectable range of the first vehicle; and step S204: determining a control decision for the first vehicle at least based on the second detection information.

When the first vehicle is in the jammed state, the control decision for the first vehicle is determined by using the detection information obtained by using the infrastructure system, the sensing limitation of the first vehicle can be broken through, and the detection information that is detected by the infrastructure system and that has wider coverage in time and space dimensions can help the first vehicle sense information out of the detectable range of the first vehicle in advance, thereby improving a sensing capability of the first vehicle and implementing a more accurate control decision.

For step S201 and step S202, the detectable range of the first vehicle may be determined based on the largest detection range of a sensor combination configured for the first vehicle. The sensor combination configured for the vehicle may include a combination constituted by one or more sensing devices such as a vehicle camera and a radar.

According to some embodiments, the first detection information may include a first following distance between the first vehicle and a vehicle ahead, and the determining, based on the first detection information, that the first vehicle is in a jammed state on a current traveling lane may include: in response to the first following distance being always less than a preset threshold within a preset time range, determining that the first vehicle is in the jammed state on the current traveling lane. In this way, a current traveling state of the first vehicle can be conveniently determined, and corresponding control can be started in a timely manner when it is determined that the first vehicle is in the jammed state at present, so that the first vehicle can exit the current jammed state as soon as possible.

According to some embodiments, the first detection information may further include a speed per hour of each of the first vehicle and the vehicle ahead. In response to the speed per hour of each of the first vehicle and the vehicle ahead being always less than a preset threshold within a preset time range, it is determined that the first vehicle is in the jammed state on the current traveling lane.

For step S203, according to some embodiments, the infrastructure system may include a roadside sensing device, a roadside calculation device, and a roadside communication device.

According to some embodiments, the infrastructure system may include: a plurality of roadside sensing devices disposed on one side or two sides of a road in an extension direction of the road and spaced from each other, where sensing ranges of every two adjacent roadside sensing devices partially overlap, such that the road is continuously covered by the sensing ranges of the plurality of roadside sensing devices; a plurality of roadside calculation devices disposed on one side or two sides of a road in an extension direction of the road and spaced from each other, where each roadside calculation device is communicatively coupled to at least one of the plurality of roadside sensing devices to receive sensing information from the at least one roadside sensing device, and is configured to process the received sensing information to obtain second detection information; and a plurality of roadside communication devices disposed on one side or two sides of a road in an extension direction of the road and spaced from each other, where each roadside communication device is communicatively coupled to at least one of the plurality of roadside calculation devices to receive the second detection information from the at least one roadside calculation device, and is configured to transmit the received second detection information to the first vehicle on the current traveling lane.

For step S204, according to some embodiments, information about a traffic event ahead of the first vehicle on the current traveling lane may be recognized based on the second detection information; and the control decision for the first vehicle may be determined based on the recognized information about the traffic event. When the first vehicle is in the jammed state on the current traveling lane, for different traffic events causing a current jam, corresponding control decisions need to be determined to control the first vehicle, thereby optimizing automatic control of the first vehicle in the jammed state.

According to some embodiments, the information about the traffic event may include one or more pieces of information such as a type, duration, and an occurrence position of the traffic event.

According to some embodiments, the control decision for the first vehicle being determined based on the recognized information about the traffic event may include: in response to determining that an anomalous traffic event occurs ahead of the first vehicle on the current traveling lane and that vehicles on at least one adjacent lane in the same direction as the current traveling lane are in an unjammed state, determining that the first vehicle moves into any one of the at least one adjacent lane.

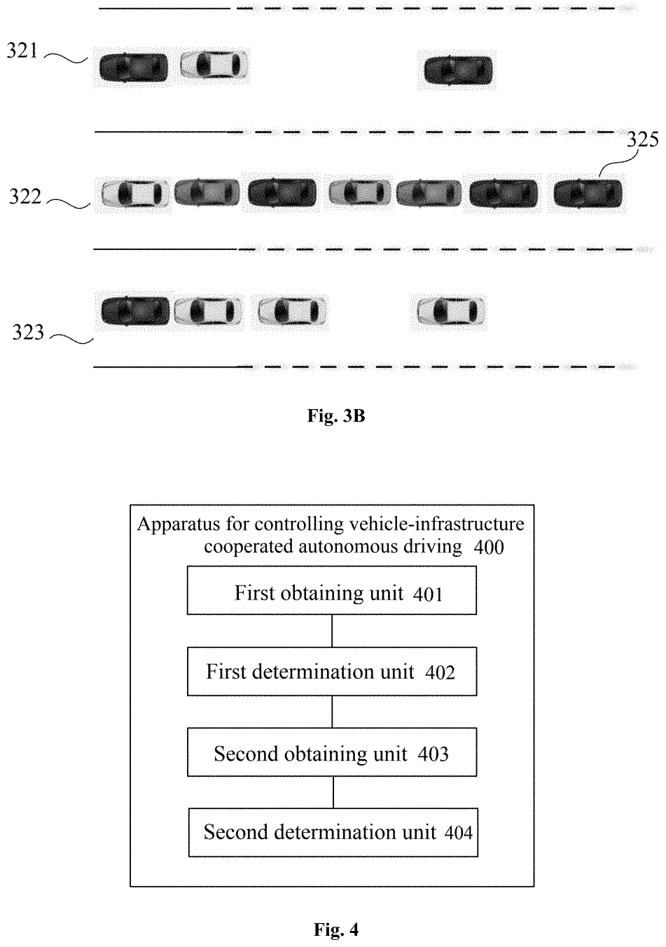

For example, as shown in FIG. 3A, when an anomalous traffic event 314 occurs on a current traveling lane 312, vehicles behind the occurrence position of the anomalous traffic event 314 cannot pass, and a first vehicle 315 behind the occurrence position on the current traveling lane 312 is caused to be in a jammed state; and vehicles ahead of the occurrence position on the current traveling lane 312 are not affected by the anomalous traffic event 314 and can still pass normally. In this case, the first vehicle 315 is controlled to move into the adjacent unjammed lane 311 or 313 and can bypass the anomalous traffic event 314 ahead on the current traveling lane 312 via the adjacent lane 311 or 313 to avoid the current jammed state as soon as possible.

Still further, after bypassing the anomalous traffic event 314 on the current traveling lane 312 via the adjacent lane 311 or 313, there is still a chance for the first vehicle 315 to move back to the current traveling lane 312 before a broken line turns into a solid line nearby a crossroads, so as to travel in an expected direction at the crossroads. The following case is avoided: When the first vehicle 315 travels to the crossroads via the adjacent lane 311 or 313 to find that the current traveling lane 312 is in a jammed state, the first vehicle 315 cannot go back to the current traveling lane 312 and can only unwillingly travel in an unexpected direction, for example, unwillingly turn left or unwillingly turn right.

According to some embodiments, the anomalous traffic event may include one or more of a traffic accident, illegal pedestrian or vehicle intrusion, a natural disaster, illegal road occupation and parking, road work, or an obstacle on the current traveling lane.

According to some embodiments, in response to a speed per hour of each one of vehicles on the adjacent lane being greater than a preset threshold, it may be determined that the vehicles on the adjacent lane are in a jammed state.

According to some embodiments, the control decision for the first vehicle being determined based on the recognized information about the traffic event may further include: in response to determining that no anomalous traffic event occurs ahead of the first vehicle on the current traveling lane, determining that the first vehicle waits on the current traveling lane.

As shown in FIG. 3B, when no anomalous traffic event occurs on a current traveling lane 322, for example, a red light at a crossroads ahead causes a jam on the current traveling lane 322, if a first vehicle 325 rashly selects to turn left to travel into an adjacent lane 323 or an adjacent lane 321 and intends to overtake, the first vehicle 325 will find, nearby the crossroads, that vehicles are in a queue on the current traveling lane 322 and thus cannot move back to the current traveling lane 322 and unwillingly travel in an unexpected direction. Therefore, when it is determined that no anomalous traffic event occurs ahead of the first vehicle 325 on the current traveling lane 322, the first vehicle 325 is controlled to wait on the current traveling lane 322, thereby optimizing an automatic control decision for the first vehicle 325.

According to some embodiments, reference control information may be further obtained by using the infrastructure system, where the reference control information may be determined by the infrastructure system based on the second detection information, and the determining a control decision for the first vehicle at least based on the second detection information may include: determining the control decision for the first vehicle based on the second detection information and the reference control information.

In this way, the control decision for the first vehicle may be assisted by the reference control information computed by the infrastructure system, so that the vehicle is prevented from being controlled by an in-vehicle autonomous driving system only, and the infrastructure system may at least partially control the first vehicle. This makes up for the deficiency of a control system of the first vehicle on automatic control of the first vehicle. For example, when the control system of the first vehicle loses control, the infrastructure system may manage the control decision for the first vehicle, to ensure effective control of the first vehicle.

The present disclosure further provides an apparatus 400 for controlling vehicle-infrastructure cooperated autonomous driving. As shown in FIG. 4, the apparatus 400 includes: a first obtaining unit 401 configured to obtain first detection information in a detectable range of a first vehicle; a first determination unit 402 configured to determine, based on the first detection information, that the first vehicle is in a jammed state on a current traveling lane; a second obtaining unit 403 configured to: in response to determining that the first vehicle is in the jammed state on the current traveling lane, obtain second detection information by using an infrastructure system, where the second detection information includes information out of the detectable range of the first vehicle; and a second determination unit 404 configured to determine a control decision for the first vehicle at least based on the second detection information.

According to some embodiments, the first detection information includes a first following distance between the first vehicle and a vehicle ahead, and the first determination unit includes: a subunit configured to: in response to the first following distance being always less than a preset threshold within a preset time range, determine that the first vehicle is in the jammed state on the current traveling lane.

According to some embodiments, the second determination unit includes: a recognition subunit configured to recognize information about a traffic event ahead of the first vehicle on the current traveling lane based on the second detection information; and a first determination subunit configured to determine the control decision for the first vehicle based on the recognized information about the traffic event.

According to some embodiments, the first determination subunit includes: a subunit configured to: in response to determining that an anomalous traffic event occurs ahead of the first vehicle on the current traveling lane and that vehicles on at least one adjacent lane in the same direction as the current traveling lane are in a normal passage state, determine that the first vehicle moves into any one of the at least one adjacent lane.

According to some embodiments, the first determination subunit further includes: a subunit configured to: in response to determining that no anomalous traffic event occurs ahead of the first vehicle on the current traveling lane, determine that the first vehicle waits on the current traveling lane.

According to some embodiments, the anomalous traffic event includes one or more of a traffic accident, illegal pedestrian or vehicle intrusion, a natural disaster, illegal road occupation and parking, road work, or an obstacle on the current traveling lane.

According to some embodiments, the apparatus further includes: a third obtaining unit configured to obtain reference control information by using the infrastructure system, where the reference control information is determined by the infrastructure system based on the second detection information, and the second determination unit further includes: a second determination subunit configured to determine the control decision for the first vehicle based on the second detection information and the reference control information.

According to some embodiments, the infrastructure system includes one or more of a roadside sensing device, a roadside calculation device, and a roadside communication device.

The present disclosure further provides an electronic device, including: a processor; and a memory communicatively connected to the processor, where the memory stores instructions executable by the processor, and when executed by the processor, the instructions cause the processor to perform any one of the foregoing methods.

The present disclosure further provides a non-transitory computer-readable storage medium storing computer instructions, where the computer instructions are used to cause a computer to perform any one of the foregoing methods.

The present disclosure further provides a computer program product, including a computer program, where when the computer program is executed by a processor, any one of the foregoing methods is implemented.

The present disclosure further provides an autonomous driving vehicle, including: a processor; and a memory communicatively connected to the processor, where the memory stores instructions executable by the processor, and when executed by the processor, the instructions cause the processor to perform any one of the foregoing methods.

The present disclosure further provides a cooperative vehicle-infrastructure system, including an infrastructure system and the foregoing autonomous driving vehicle.

In the technical solutions of the present disclosure, obtaining, storage, application, etc. of personal information of a user all comply with related laws and regulations and are not against the public order and good morals.

According to the embodiments of the present disclosure, there are further provided an electronic device, a readable storage medium, and a computer program product.

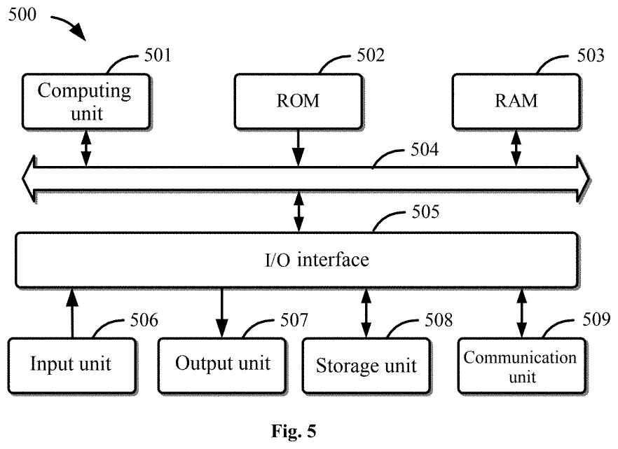

Referring to FIG. 5, a structural block diagram of an electronic device 500 that can serve as a server or a client of the present disclosure is now described, which is an example of a hardware device that can be applied to various aspects of the present disclosure. The electronic device is intended to represent various forms of digital electronic computer devices, such as a laptop computer, a desktop computer, a workstation, a personal digital assistant, a server, a blade server, a mainframe computer, and other suitable computers. The electronic device may further represent various forms of mobile apparatuses, such as a personal digital assistant, a cellular phone, a smartphone, a wearable device, and other similar computing apparatuses. The components shown herein, their connections and relationships, and their functions are merely examples, and are not intended to limit the implementation of the present disclosure described and/or required herein.

As shown in FIG. 5, the device 500 includes a computing unit 501, which may perform various appropriate actions and processing according to a computer program stored in a read-only memory (ROM) 502 or a computer program loaded from a storage unit 508 to a random access memory (RAM) 503. The RAM 503 may further store various programs and data required for the operation of the device 500. The computing unit 501, the ROM 502, and the RAM 503 are connected to each other through a bus 504. An input/output (I/O) interface 505 is also connected to the bus 504.

A plurality of components in the device 500 are connected to the I/O interface 505, including: an input unit 506, an output unit 507, the storage unit 508, and a communication unit 509. The input unit 506 may be any type of device capable of entering information to the device 500. The input unit 506 can receive entered digit or character information, and generate a key signal input related to user settings and/or function control of the electronic device, and may include, but is not limited to, a mouse, a keyboard, a touchscreen, a trackpad, a trackball, a joystick, a microphone, and/or a remote controller. The output unit 507 may be any type of device capable of presenting information, and may include, but is not limited to, a display, a speaker, a video/audio output terminal, a vibrator, and/or a printer. The storage unit 508 may include, but is not limited to, a magnetic disk and an optical disc. The communication unit 509 allows the device 500 to exchange information/data with other devices via a computer network such as the Internet and/or various telecommunications networks, and may include, but is not limited to, a modem, a network interface card, an infrared communication device, a wireless communication transceiver and/or a chipset, e.g., a Bluetooth™ device, a 802.11 device, a Wi-Fi device, a WiMAX device, a cellular communication device, and/or the like.

The computing unit 501 may be various general-purpose and/or special-purpose processing components with processing and computing capabilities. Some examples of the computing unit 501 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, etc. The computing unit 501 performs the various methods and processing described above, for example, the method for controlling vehicle-infrastructure cooperated autonomous driving. For example, in some embodiments, the method for controlling vehicle-infrastructure cooperated autonomous driving may be implemented as a computer software program, which is tangibly contained in a machine-readable medium, such as the storage unit 508. In some embodiments, a part or all of the computer program may be loaded and/or installed onto the device 500 via the ROM 502 and/or the communication unit 509. When the computer program is loaded onto the RAM 503 and executed by the computing unit 501, one or more steps of the method for controlling vehicle-infrastructure cooperated autonomous driving can be performed. Alternatively, in other embodiments, the computing unit 501 may be configured, by any other suitable means (for example, by means of firmware), to perform the method for controlling vehicle-infrastructure cooperated autonomous driving.

Various implementations of the systems and technologies described herein above can be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logical device (CPLD), computer hardware, firmware, software, and/or a combination thereof. These various implementations may include: The systems and technologies are implemented in one or more computer programs, where the one or more computer programs may be executed and/or interpreted on a programmable system including at least one programmable processor. The programmable processor may be a dedicated or general-purpose programmable processor that can receive data and instructions from a storage system, at least one input apparatus, and at least one output apparatus, and transmit data and instructions to the storage system, the at least one input apparatus, and the at least one output apparatus.

Program codes used to implement the method of the present disclosure can be written in any combination of one or more programming languages. These program codes may be provided for a processor or a controller of a general-purpose computer, a special-purpose computer, or other programmable data processing apparatuses, such that when the program codes are executed by the processor or the controller, the functions/operations specified in the flowcharts and/or block diagrams are implemented. The program codes may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may contain or store a program for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein can be implemented on a computer which has: a display apparatus (for example, a cathode-ray tube (CRT) or a liquid crystal display (LCD) monitor) configured to display information to the user; and a keyboard and a pointing apparatus (for example, a mouse or a trackball) through which the user can provide an input to the computer. Other types of apparatuses can also be used to provide interaction with the user; for example, feedback provided to the user can be any form of sensory feedback (for example, visual feedback, auditory feedback, or tactile feedback), and an input from the user can be received in any form (including an acoustic input, a voice input, or a tactile input).

The systems and technologies described herein can be implemented in a computing system (for example, as a data server) including a backend component, or a computing system (for example, an application server) including a middleware component, or a computing system (for example, a user computer with a graphical user interface or a web browser through which the user can interact with the implementation of the systems and technologies described herein) including a frontend component, or a computing system including any combination of the backend component, the middleware component, or the frontend component. The components of the system can be connected to each other through digital data communication (for example, a communications network) in any form or medium. Examples of the communications network include: a local area network (LAN), a wide area network (WAN), and the Internet.

A computer system may include a client and a server. The client and the server are generally far away from each other and usually interact through a communications network. A relationship between the client and the server is generated by computer programs running on respective computers and having a client-server relationship with each other. The server may be a cloud server, a server in a distributed system, or a server combined with a blockchain.

It should be understood that steps may be reordered, added, or deleted based on the various forms of procedures shown above. For example, the steps recorded in the present disclosure may be performed in parallel, in order, or in a different order, provided that the desired result of the technical solutions disclosed in the present disclosure can be achieved, which is not limited herein.

Although the embodiments or examples of the present disclosure have been described with reference to the drawings, it should be appreciated that the methods, systems, and devices described above are merely example embodiments or examples, and the scope of the present disclosure is not limited by the embodiments or examples, but only defined by the appended authorized claims and equivalent scopes thereof. Various elements in the embodiments or examples may be omitted or substituted by equivalent elements thereof. Moreover, the steps may be performed in an order different from that described in the present disclosure. Further, various elements in the embodiments or examples may be combined in various ways. It is important that, as the technology evolves, many elements described herein may be replaced with equivalent elements that appear after the present disclosure.

What is claimed is:

1. A method, comprising:
obtaining first detection information in a detectable range of a first vehicle;
determining, based on the first detection information, that the first vehicle is in a jammed state on a current traveling lane;
in response to determining that the first vehicle is in the jammed state on the current traveling lane, obtaining second detection information by using an infrastructure system, wherein the second detection information comprises information out of the detectable range of the first vehicle; and
determining a control decision for the first vehicle based on the second detection information.

2. The method according to claim 1, wherein the first detection information comprises a first following distance between the first vehicle and a vehicle ahead of the first vehicle in the current traveling lane, and wherein the determining, based on the first detection information, that the first vehicle is in the jammed state on the current traveling lane comprises:
in response to the first following distance being less than a threshold distance throughout a time range, determining that the first vehicle is in the jammed state on the current traveling lane.

3. The method according to claim 1, wherein the determining the control decision for the first vehicle based on the second detection information comprises:
recognizing information about a traffic event ahead of the first vehicle on the current traveling lane based on the second detection information; and
determining the control decision for the first vehicle based on the information about the traffic event.

4. The method according to claim 3, wherein the determining the control decision for the first vehicle based on the information about the traffic event comprises:
in response to determining that an anomalous traffic event occurs ahead of the first vehicle on the current traveling lane and that vehicles on at least one adjacent lane in a same direction as the current traveling lane are in an unjammed state, determining that the first vehicle moves into any one of the at least one adjacent lane.

5. The method according to claim 4, wherein the determining the control decision for the first vehicle based on the information about the traffic event further comprises:
in response to determining that no anomalous traffic event occurs ahead of the first vehicle on the current traveling lane, determining that the first vehicle waits on the current traveling lane.

6. The method according to claim 4, wherein the anomalous traffic event comprises one or more of a traffic accident, illegal pedestrian or vehicle intrusion, a natural disaster, illegal road occupation and parking, road work, or an obstacle on the current traveling lane.

7. The method according to claim 1, further comprising:
obtaining reference control information by using the infrastructure system, wherein the reference control information is determined by the infrastructure system based on the second detection information,
wherein the determining the control decision for the first vehicle based on the second detection information comprises:
determining the control decision for the first vehicle based on the second detection information and the reference control information.

8. The method according to claim 1, wherein the infrastructure system comprises a roadside sensing device, a roadside calculation device, or a roadside communication device.

9. An electronic device, comprising:
a processor; and
a memory communicatively connected to the processor, wherein the memory stores instructions executable by the processor, and when executed by the processor, the instructions cause the processor to perform acts including:
obtaining first detection information in a detectable range of a first vehicle;
determining, based on the first detection information, that the first vehicle is in a jammed state on a current traveling lane;
in response to determining that the first vehicle is in the jammed state on the current traveling lane, obtaining second detection information by using an infrastructure system, wherein the second detection information comprises information out of the detectable range of the first vehicle; and
determining a control decision for the first vehicle based on the second detection information.

10. The device according to claim 9, wherein the first detection information comprises a first following distance between the first vehicle and a vehicle ahead of the first vehicle in the current traveling lane, and wherein the determining, based on the first detection information, that the first vehicle is in the jammed state on the current traveling lane comprises:
in response to the first following distance being less than a threshold distance throughout a time range, determining that the first vehicle is in the jammed state on the current traveling lane.

11. The device according to claim 9, wherein the determining the control decision for the first vehicle based on the second detection information comprises:
recognizing information about a traffic event ahead of the first vehicle on the current traveling lane based on the second detection information; and
determining the control decision for the first vehicle based on the information about the traffic event.

12. The device according to claim 11, wherein the determining the control decision for the first vehicle based on the information about the traffic event comprises:
in response to determining that an anomalous traffic event occurs ahead of the first vehicle on the current traveling lane and that vehicles on at least one adjacent lane in a same direction as the current traveling lane are in an unjammed state, determining that the first vehicle moves into any one of the at least one adjacent lane.

13. The device according to claim 12, wherein the determining the control decision for the first vehicle based on the information about the traffic event further comprises:
in response to determining that no anomalous traffic event occurs ahead of the first vehicle on the current traveling lane, determining that the first vehicle waits on the current traveling lane.

14. The device according to claim 12, wherein the anomalous traffic event comprises one or more of a traffic accident, illegal pedestrian or vehicle intrusion, a natural disaster, illegal road occupation and parking, road work, or an obstacle on the current traveling lane.

15. The device according to claim 9, the acts further including:
obtaining reference control information by using the infrastructure system, wherein the reference control information is determined by the infrastructure system based on the second detection information,
wherein the determining the control decision for the first vehicle based on the second detection information comprises:
determining the control decision for the first vehicle based on the second detection information and the reference control information.

16. The device according to claim 9, wherein the infrastructure system comprises a roadside sensing device, a roadside calculation device, or a roadside communication device.

17. A non-transitory computer-readable storage medium storing computer instructions that, when executed by a processor in a computer, cause the computer to perform acts including:
obtaining first detection information in a detectable range of a first vehicle;
determining, based on the first detection information, that the first vehicle is in a jammed state on a current traveling lane;
in response to determining that the first vehicle is in the jammed state on the current traveling lane, obtaining second detection information by using an infrastructure system, wherein the second detection information comprises information out of the detectable range of the first vehicle; and
determining a control decision for the first vehicle based on the second detection information.

18. The storage medium according to claim 17, wherein the first detection information comprises a first following distance between the first vehicle and a vehicle ahead of the first vehicle in the current traveling lane, and wherein the determining, based on the first detection information, that the first vehicle is in the jammed state on the current traveling lane comprises:
in response to the first following distance being less than a threshold distance throughout a time range, determining that the first vehicle is in the jammed state on the current traveling lane.

19. The storage medium according to claim 17, wherein the determining the control decision for the first vehicle based on the second detection information comprises:
recognizing information about a traffic event ahead of the first vehicle on the current traveling lane based on the second detection information; and
determining the control decision for the first vehicle based on the information about the traffic event.

20. The storage medium according to claim 19, wherein the determining the control decision for the first vehicle based on the information about the traffic event comprises:
in response to determining that an anomalous traffic event occurs ahead of the first vehicle on the current traveling lane and that vehicles on at least one adjacent lane in a same direction as the current traveling lane are in an unjammed state, determining that the first vehicle moves into any one of the at least one adjacent lane.
